(19) United States
(12) Patent Application Publication
(10) Pub. No.: US 2015/0033188 A1
(43) Pub. Date: Jan. 29, 2015

(54) SCROLLABLE SMART MENU

(71) Applicant: Microsoft Corporation, Redmond, WA (US)

(72) Inventor: Renu Devi, Redmond, WA (US)

(73) Assignee: Microsoft Corporation, Redmond, WA (US)

(21) Appl. No.: 13/948,813

(22) Filed: Jul. 23, 2013

(51) Int. Cl. G06F 3/0484; G06F 3/0485; G06F 3/0482

(52) U.S. Cl. CPC G06F 3/04842; G06F 3/0482; G06F 3/0485
USPC 715/824; 715/830

(57) ABSTRACT

Technologies are generally described for providing a scrollable context menu for interacting with content displayed on a user interface. The scrollable context menu may include a base set of commands available for execution on selected textual and other content. A user may scroll the menu to display a carousel of additional available options employing traditional input such as mouse and stylus input and employing touch and gesture based interaction. The scrollable context menu may present visual cues to indicate that additional options are available. Each command in the base set of commands displayed on the scrollable context menu may be a command commonly used by a user and associated with a user profile unique to the user. The user profile may be saved such that commonly used commands may be preserved and displayed each time the scrollable context menu is presented to the user from any application or device.

### BACKGROUND

With the proliferation of computing and networking technologies, two aspects of computing devices have become prevalent: non-traditional (e.g., mouse and keyboard) input mechanisms such as touch and gesture input and smaller interfaces and screen sizes of devices. Screen real estate is very valuable in smaller interfaces, such as tablets and phones, and menus for interacting with content on smaller interfaces have special constraints and challenges. Menus and toolbars that provide options and commands for interacting with content may present a wide variety of options and may consume a large portion of interface real estate.

As users increasingly demand more options to interact with content, traditional context menus can become obtrusive leaving the user with less visibility of displayed content. Some menus may preserve screen real estate by reducing the options offered in the contextual menu, causing the user to have to look elsewhere for more options. Other menus offer more options, by creating nested menus which can be cumbersome and difficult to use. Additionally, presentation of a large number of options may reduce an optimal application performance as each displayed option may need to be rendered at the application which can consume resources and slow performance.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed providing a scrollable context menu for interacting with content displayed on a user interface. An example scrollable context menu may include a base set of commands available for execution on selected textual and other content. A user may scroll the menu to display a carousel of additional available options employing traditional input such as mouse and stylus input and employing touch and gesture based interaction. Each command in the base set of commands displayed on the scrollable context menu may be a command commonly used by a user and associated with a user profile unique to the user. The user profile may be saved such that commonly used commands may be preserved and displayed each time the scrollable context menu is presented to the user from any application or device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example environment where a scrollable smart context menu may be employed;

FIG. 2 illustrates an example scrollable context menu displayed on a user interface of a client device;

FIG. 3 illustrates some example scrollable context menu configurations;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of presenting a scrollable smart context menu, according to embodiments.

### DETAILED DESCRIPTION

As briefly described above, a scrollable context menu may be provided for enabling a user to interact with content on a client device. The scrollable context menu may include a base set of frequently used commands for interacting with textual and other content. The scrollable context menu may provide additional available commands, which may be arranged in a carousel configuration, such that a user may scroll the menu to display the additional available options. The scrollable context menu may be navigated employing traditional input such as mouse and stylus input and employing touch and gesture based interaction. The set of commands most frequently used by the user may be stored in a user profile unique to the user. The user profile may be saved such that commonly used commands may be preserved and displayed each time the scrollable context menu is presented to the user from any application or device.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a touch-enabled or gesture-enabled menu may refer to context based command menus that make use of features specific to touch or gesture enabled computing devices, but may also work with a traditional mouse and keyboard. Context menus may be used to provide quick access to commonly used commands while viewing or editing documents, entails, contact lists, other communications, or any content (e.g., audio, video, etc.). Context base menus may appear as part of a user interface's regular menu, in a separate viewing pane (e.g., a window) outside or inside the user interface, and so on. Typically, context based menus may present a limited set of commands for easy user access, but additional sub-menus such as drop down menus may be presented upon user selection. Commonly used context based menus may appear over the viewed document.

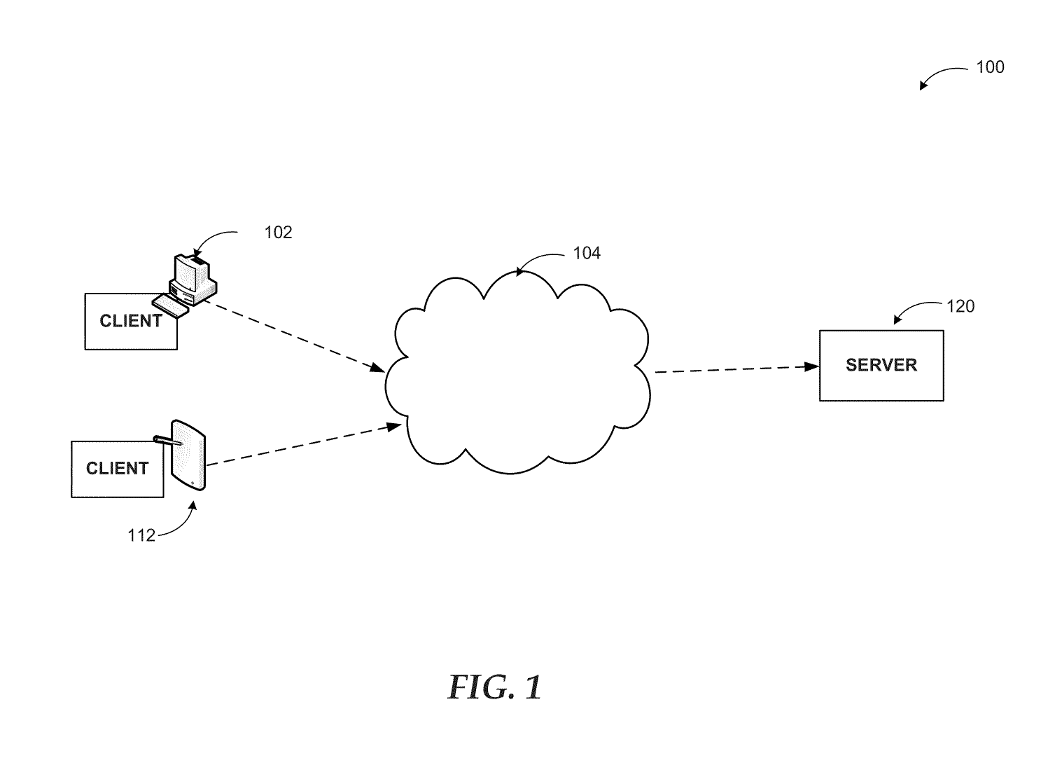

FIG. 1 illustrates an example environment where a scrollable smart context menu may be employed, according to some embodiments herein. As touch and gesture based technologies are proliferating and computing devices employing those technologies are becoming common, user interface arrangement becomes a challenge. Touch and/or gesture based devices, specifically portable devices, tend to have smaller screen size, which means less available space for user interfaces. For example, in a user interface that enables editing of a document (text and/or graphics), in addition to the presented portion of the document, a virtual keyboard may have to be displayed further limiting the available space (“real estate”). In such scenarios, providing a full control menu or toolbar may be impractical or impossible. Embodiments are directed to providing a scrollable smart context menu for displaying available commands and preserving user interface real estate.

As mentioned above, smaller available display space, larger content, and different aspect ratios make conventional menus and toolbars impractical and inefficient. Existing touch-based devices such as tablet PCs and similar ones are typically directed to data consumption (i.e., viewing). On the other hand, commonly used applications such as word processing applications, spreadsheet applications, presentation applications, and comparable ones are directed to content creation, e.g. generating and editing documents with textual, graphical, and other content. Example currently available menus and toolbars may be displayed on the user interface in addition to displayed content and may consume a large portion of interface real estate. Additionally, the currently available menus may display a large number of available commands that may rarely be selected or used by a user. Furthermore, network resources may be consumed to load and activate the commands displayed on the menus and toolbars, even if the commands are unselected and unused by the user.

A scrollable smart context menu, according to embodiments, may dynamically provide a base set of available commands to conserve interface real estate, and the set of commands presented may be based on a user's previous selections. Diagram 100 illustrates some example devices (102, 112) where a touch or gesture enabled, scrollable smart context menu may be provided. In an example embodiment, a user may interact with content on a user's client device such as a tablet 112 or personal computer 102. Example content may be accessed through word processing applications, spreadsheet applications, presentation applications, and other similar applications. Data associated with the applications and content may be provided over a network 104 such as a cloud based network such that the data may be stored locally at the user's computing device and also at a remote server 120 accessed over the network 104.

In a system according to embodiments, a profile may be associated with a user, and the user profile may also be stored at the remote server 120. The user profile may include information associated with a user's preferences when interacting with particular applications and content on the user's local device. The user profile may also be configured to store a user's commonly selected commands from a presented scrollable smart context menu. In an example scenario, the user profile may store commands the user commonly uses when interacting with a particular object displayed on the interface, such as textual content, an image, or a table, for example. When selection of an object by the user is detected, the user's profile may be retrieved, and a scrollable smart context menu associated with the selected object may be presented. The scrollable smart context menu may present a set of commands the user has most frequently interacted with for formatting or customizing the object in the application. In another embodiment, the scrollable smart context menu may present a set of commands the user has most recently interacted with.

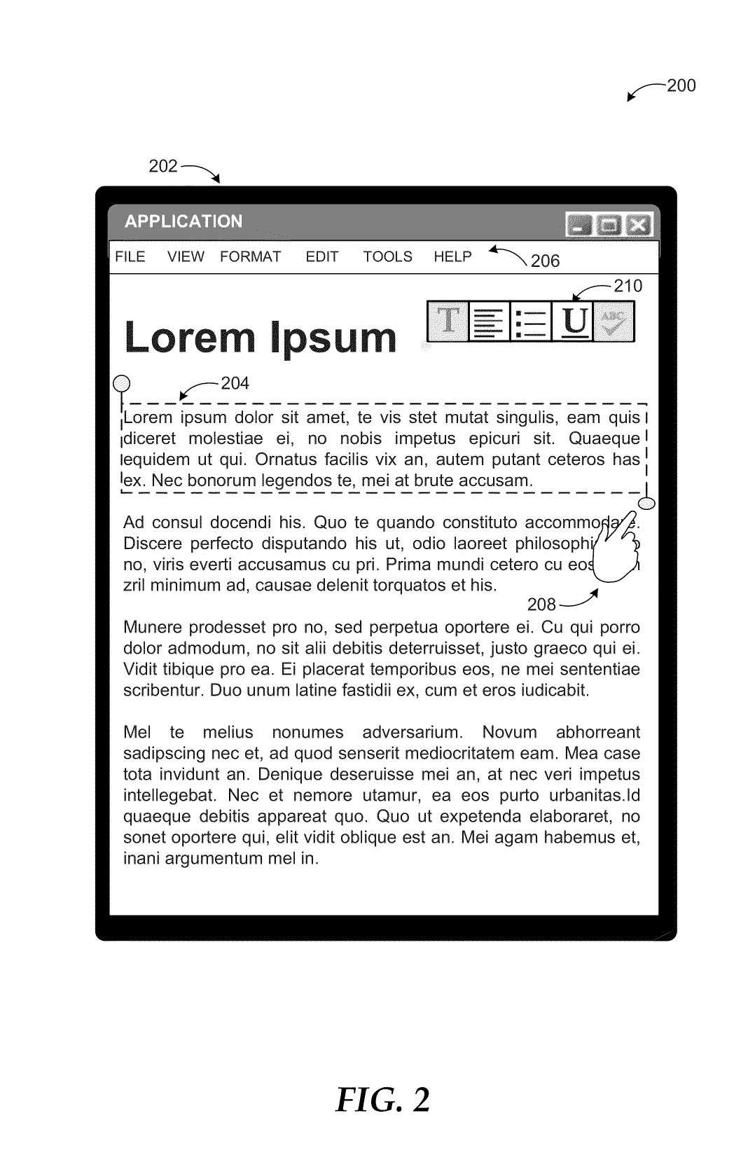

FIG. 2 illustrates an example scrollable context menu displayed on a user interface of a client device, according to embodiments herein. As illustrated in diagram 200, a scrollable smart context menu may be displayed on a user interface of a client device to present available commands to a user while preserving real estate of the user interface. Device 202 is an example device providing an interface where a user may interact with content employing traditional input such as a mouse, stylus and keyboard, and touch/gesture input. Example devices may include a tablet (or slate), a touch enabled computer monitor, a smart phone, a mobile computing device, a personal computer, a laptop, a whiteboard, and other similar devices enabling traditional input and touch/gesture input.

In a system according to embodiments, a scrollable smart context menu 210 may be presented on the user interface of the device 202 to provide available commands for interacting with displayed content. The scrollable smart context menu 210 may be configured to preserve real estate on the user interface, and to present options that the user most commonly uses. Such a menu may be implemented in any application that enables content to be viewed and/or edited, as well as in operating system user interfaces.

In an example embodiment, the commands displayed on the scrollable smart context menu 210 may be object specific commands. For example, an object that the user is currently interacting with may be detected, and the scrollable smart context menu 210 may present relevant commands for interacting with the object. Example objects may include, text, images, tables, charts, lists, and other similar content. The scrollable smart context menu 210 may be automatically displayed upon detection of a selected object. In another example embodiment, the scrollable smart context menu 210 may be invoked by a user employing a right click on a mouse or a similar action for selecting to activate the scrollable smart context menu 210. Upon invocation of the scrollable smart context menu 210, the scrollable smart context menu may present a base set of object specific commands. The scrollable smart context menu 210 may be displayed near a menu bar 206 of the application. In other embodiments, the scrollable smart context menu 210 may be a dynamic menu, and may be positioned near a selected object on the interface. The base set of commands may include at least three commands that the user may select. Additional commands may be provided on either side of the base set of commands. For example one additional command may precede the base set of commands and another additional command may follow presented base set of commands. The additional available commands may be accessed by navigating the scrollable smart context menu 210 employing input such as a swipe action to the left or to the right.

In an example embodiment, in order to indicate to the user that additional commands may be available, at least one additional command may be displayed on the scrollable smart context menu 210 along with the base set of commands. The additional command may be in active and not be available for selection, but may serve as a visual cue to the user that other commands may be available. The additional inactive command may be shaded, or grayed out, in order to indicate that the user may navigate to the shaded command in order to render and activate the command to make the command available for selection. Other schemes may also be employed to indicate that the user may scroll to view additional commands, such as a coloring scheme, highlighting scheme, magnification scheme, and animation scheme.

In an example scenario, at least one shaded command may be provided preceding the base set of commands and at least one shaded command may be provided following the base set of commands, indicating that the user may navigate in two directions to access additional commands. The commands on the scrollable smart context menu 210 may be arranged in a carousel configuration, or a 360 degree configuration, such that the user may scroll in either direction to continuously access additional commands. A user may employ a swipe action, or a mouse scroll, to continuously load commands in the direction of the swipe or scroll. Additionally, the user may employ a tap action or a mouse click, for example, to incrementally load one action at a time in response to the tap or click.

In a further embodiment, as previously described, the scrollable smart context menu 210 may present a set of commands the user has most frequently interacted with for formatting or customizing the object. Presenting the most frequently used commands may facilitate providing a few options that the user is likely to use to interact with an object without occupying interface real estate, and without burdening the user with too many options. Furthermore, presenting a limited number of most frequently used commands may optimize performance of an application executed at the device 202, because only the presented commands may be rendered and activated, while only icons for additional commands may be presented. Rendering and activation of the additional commands may be delayed until the user navigates to an additional command on the scrollable smart context menu 210 and selects the command.

In a system according to embodiments, the presented base set of commands may be a result of the user's previous interactions with the object, and/or formatting or other interactions with similar or related objects in the document, spreadsheet or presentation application. For example, when the user interacts with an object, the application may store the options the user used for a specific object type and may save the options in a user profile. The stored options may be prioritized, and the next time the user invokes the context menu for the object or similar object type, the stored prioritized options may be presented in the base set of commands on the scrollable smart context menu 210. In some examples the prioritized options may be the most frequently used commands related to an object, and in other examples, the prioritized options may be most recently used commands.

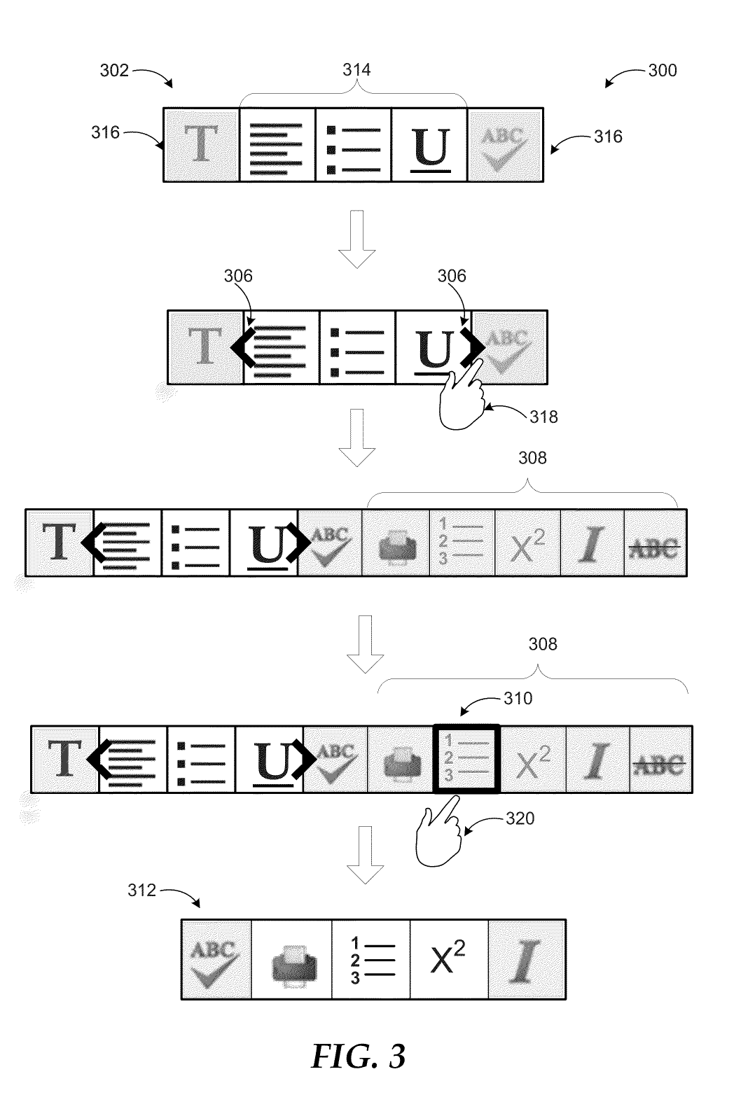

FIG. 3 illustrates some example scrollable context menu configurations, according to some example embodiments. As illustrated in diagram 300, upon detection of selection of an object on a user interface, a scrollable smart context menu 302 may be activated. The scrollable smart context menu 302 may be configured to provide a base set 314 of commands for interacting with the selected object. The base set 314 of commands may be the most frequent commands a user has previously used to interact with, format, and customize the object or similar object types. In another example, the base set 314 of commands may be the commands the user most recently used to interact with the object.

In an example embodiment, the scrollable smart context menu 302 may present three commands in the base set 314 of commands in a ribbon type menu, for example. Each command on the scrollable smart context menu may be displayed as a button with an icon, image, or text to represent the command. Other color, graphical and animation schemes may also be used to represent the command. The ribbon menu may be configured as a carousel of commands, such that additional commands may be continuously accessed and loaded by navigating to the left and right of the ribbon menu. The scrollable smart context menu may also present at least one additional command 316 on both sides of the base set 314 of commands to indicate to the user that additional commands may be available. The additional commands 316 may be shaded or grayed out to indicate that the commands have not yet been rendered and activated, but that the user may scroll in the direction of a grayed out command to load the command or navigate to additional commands.

In another example embodiment, visual cues or indicators 306, such as arrows, chevrons, or other similar indicators may be displayed to indicate that additional commands may be available. The user may gesture 318 on or in a direction of one of the indicators 306 to display the additional commands. For example, a touching, swiping, pressing and holding, dragging/sliding or similar action may serve as activation to scroll to the additional commands. Additionally, a mouse wheel may be employed to scroll in a direction of the indicator. For example, a mouse wheel scroll-up may scroll the scrollable smart context menu in one direction and a mouse wheel scroll-down may scroll the scrollable smart context menu in the other direction.

In a system according to embodiments, upon detection of an action to scroll to additional commands on the scrollable smart context menu 302, the scrollable smart context menu 302 may expand to present an expanded region 308 that may present two or more available commands in the direction of the scrolling. The user may select 320 a command 310 from the expanded region 308. The command 310 may be marked as selected by highlighting the command, shading the command, magnifying the command, and re-coloring the command. Upon detection of selection of the command 310 from the expanded region 308, the scrollable smart context menu 302 may return to a condensed version 312 displaying a base set of actions, where the selected command 310 may positioned as a center command in the base set of commands. The centered command and at least one command on either side of the centered command may be rendered and activated. Additionally, a shaded command may be displayed on both sides of the new base set of commands.

The user may select a command from the scrollable smart context menu 302 to perform the action associated with the command on the selected object. The command may be selected employing a touch action such as a tap and a mouse input such as a click. When the user completes interacting with the object, the type of options and commands used by the user may be stored in the user's profile and displayed in a scrollable smart context menu the next time the user needs opens an application and interacts with a similar object.

The example configurations, indicators, and context based menus depicted in FIGS. 1-3 are provided for illustration purposes only. Embodiments are not limited to the shapes, forms, and content shown in the example diagrams, and may be implemented using other textual, graphical, and similar schemes employing the principles described herein

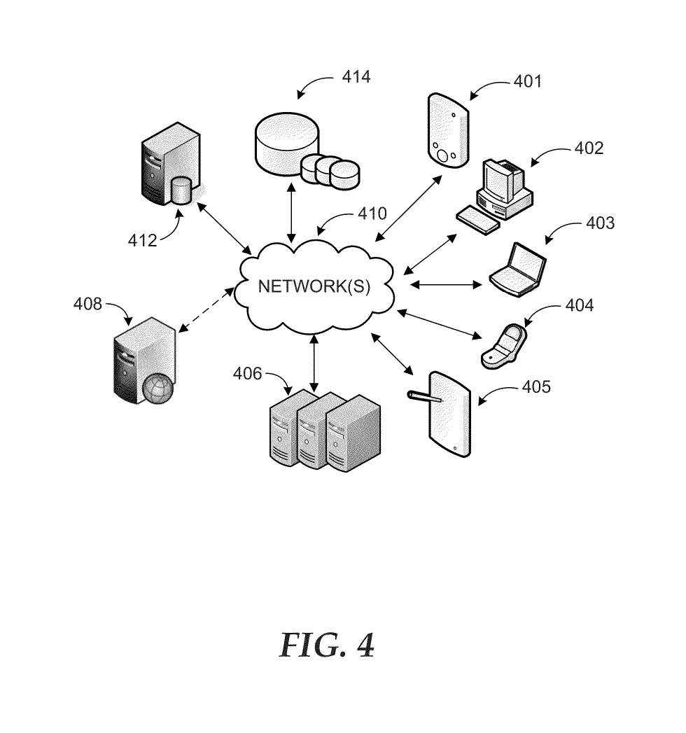

FIG. 4 is an example networked environment, where embodiments may be implemented. In addition to locally installed applications, such as application 822 discussed below, a scrollable smart context menu may also be employed in conjunction with hosted applications and services that may be implemented via software executed over one or more servers 406 or individual server 408. A hosted service or application may communicate with client applications on individual computing devices such as a handheld computer 401, a desktop computer 402, a laptop computer 403, a smart phone 404, a tablet computer for slate), 405 (‘client devices’) through network(s) 410 and control a user interface presented to users.

As discussed, a scrollable context menu may present commonly used commands for controlling functionality provided by the hosted service or application. Additional commands associated with the scrollable context menus may be presented by swiping left and right to reveal the additional commands.

Client devices 401-405 are used to access the functionality provided by the hosted service or application. One or more of the servers 406 or server 408 may be used to provide a variety of services as discussed above. Relevant data may be stored in one or more data stores (e.g. data store 414), which may be managed by any one of the servers 406 or by database server 412.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation network(s) 410 may include wireless media such as acoustic, RF, infrared and other wireless media.

Many other configurations of computing devices, applications, data sources, and data distribution systems may be employed to provide a scrollable context menu. Furthermore, the networked environments discussed in FIG. 4 are for illustration purposes only. Embodiments are not limited to the example applications, modules, or processes.

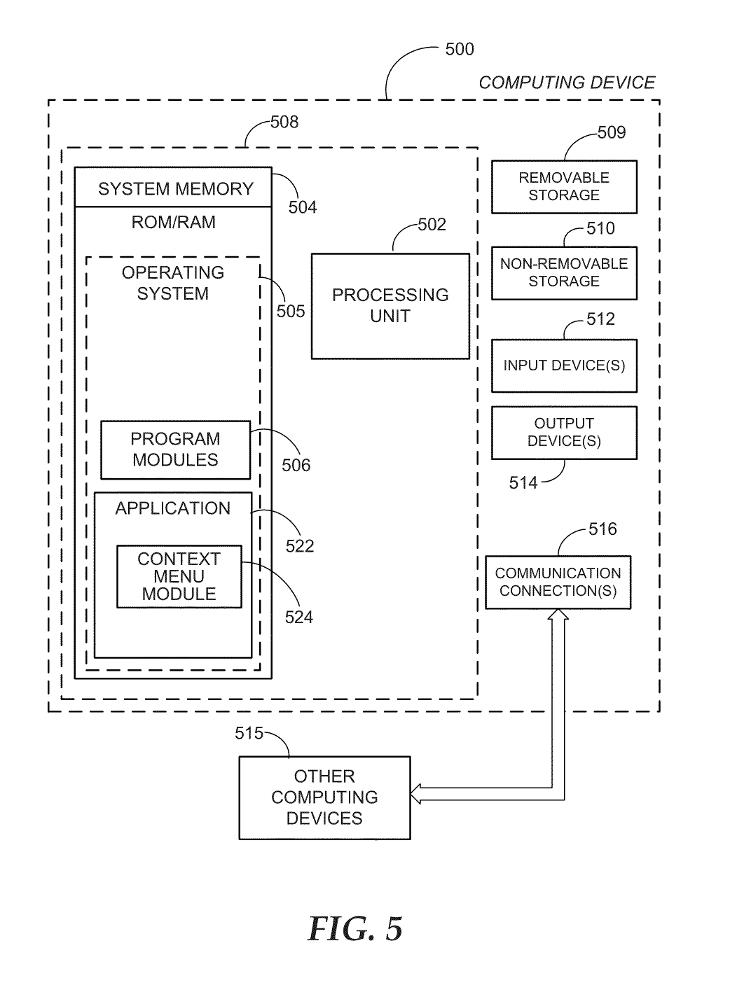

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any touch and/or gesture enabled device in stationary, mobile, or other form such as the example devices discussed in conjunction with FIGS. 1A, 1B, and 7, and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 508 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as program modules 506, application 522 and context menu module 524.

Context menu module 524 may operate in conjunction with the operating system 508 or application 522 and provide a touch and/or gesture enabled scrollable smart context menu as discussed previously. The context menu module 524 may present a base set of most commonly used commands associated with a particular user, and may present additional commands in response to an interaction with a visual cue presented on the menu, such as a swipe or other input in a direction of the visual cue. An example visual cue may be a shaded icon for an additional command. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 515, such as over a wireless network in a distributed computing environment, a satellite link, a cellular link, and comparable mechanisms. Other devices 515 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

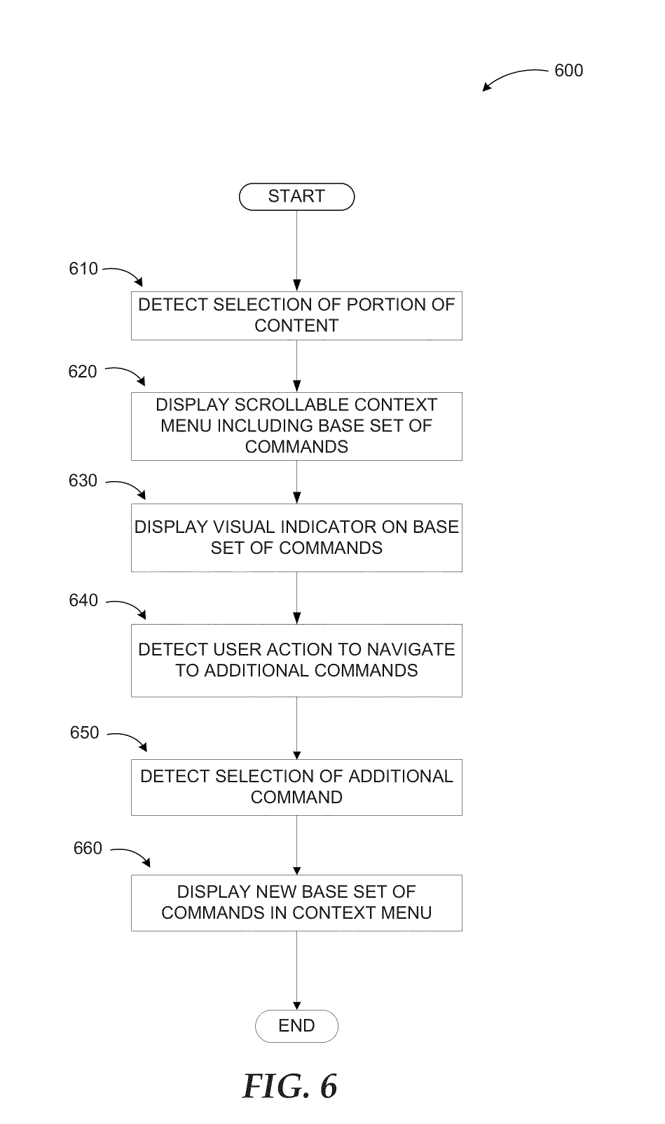

FIG. 6 illustrates a logic flow diagram for a process of presenting a scrollable smart context menu, according to embodiments. Process 600 may be implemented as part of an application or an operating system.

Process 600 begins with optional operation 610, where a portion of content displayed on a user interface of a client device may be detected. A portion of content may include objects such as text, images, tables, lists, charts, and other similar objects. At operation 620 upon detection of the selection of a portion of content, a context menu including a base set of commands for interacting with the selected portion of content may be detected. The base set of commands may include at least three most frequently used commands for interacting with the portion of content. At operation 630, visual indicators may be provided to indicate that one or more additional commands are available. A visual indicator may be additional inactive commands on either side of the base set of commands, where the additional inactive commands may be shaded or grayed out to indicate that they are inactive. A visual indicator may also be an arrow, chevron or pointer that indicates additional commands are available in the direction of the indicator.

At operation 640, a user action to navigate to the one or more additional commands may be detected. A user action may include a swipe or scroll in a direction of the inactive commands, and may also be a tap and hold or a mouse click on a visual indicator, for example. At operation 650, a selection of an additional command may be detected, and at operation 660, upon detection of selection of the additional command, a new base set of commands may be displayed in the context menu, where the selected command may be positioned at the center of the new base set of commands.

The operations included in process 600 are for illustration purposes. Presenting a scrollable context menu according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing a scrollable smart context menu, the method comprising:
detecting selection of a portion of content displayed on a user interface of a client device;
displaying a context menu including a base set of commands for interacting with the selected portion of content;
displaying a visual indicator for indicating that one or more additional commands are available for execution on the selected portion of content;
detecting a user action to navigate to the one or more additional commands; and
upon detection of selection of an additional command, displaying a new base set of commands.

2. The method of claim 1, wherein displaying a visual indicator comprises:
displaying at least one inactive command preceding the base set of commands and at least one inactive command following the base set of commands, wherein the inactive command has not yet been rendered.

3. The method of claim 2, further comprising:
shading at least one inactive command preceding the base set of commands and the at least one inactive command following the base set of commands to indicate that the command is inactive and not yet rendered.

4. The method of claim 1, wherein displaying a visual indicator further comprises:
displaying one or more of: an arrow, a chevron, and a pointer on the base set of claims to indicate that additional commands are available in a direction of the indicator.

5. The method of claim 1, wherein detecting a user action to navigate to the one or more additional commands comprises:
detecting one or more of: a tap action on the visual indicator for the command on the user interface, a swipe action on the visual indicator for the command on the user interface, a press and hold action on the visual indicator for the command on the user interface, a keyboard entry combination, a mouse input, and a pen input.

6. The method of claim 1, further comprising:
in response to detecting the user action to navigate to the one or more additional commands, continuously displaying new additional commands in the base set of commands.

7. The method of claim 1, further comprising:
in response to detecting the user action to navigate to the one or more additional commands, displaying an expanded region in addition to the base set of commands, wherein the expanded region displays two or more additional commands.

8. The method of claim 7, further comprising:
enabling the user to perform a second user action on one of the additional commands from the expanded region to select the additional command for display in the base set of commands.

9. The method of claim 8, further comprising:
upon detection of selection of the additional commands from the expanded region, positioning the selected command in a center position of the base set of commands and hiding the expanded region.

10. The method of claim 1, further comprising:
displaying at least three commands in the base set of commands.

11. The method of claim 1, wherein displaying a context menu including a base set of commands comprises:
displaying a most frequently used set of commands for interacting with the selected portion of content in the base set of commands.

12. A computing device for providing a scrollable smart context menu, the computing device comprising:
an input device;
a memory;
a processor coupled to the memory and the input device, the processor executing an application and causing a user interface associated with the application to be displayed on a screen, wherein the processor is configured to:
detect selection of a portion of content displayed on a user interface of a client device;
display a context menu including a base set of commands for interacting with the selected portion of content;
display at least two inactive commands, wherein one inactive command precedes the base set of commands and one inactive command follows the base set of commands to indicate that one or more additional commands are available for execution on the selected portion of content;
detect a user action to navigate to the one or more additional commands; and
upon detection of selection of an additional command, display a new base set of commands.

13. The computing device of claim 12, wherein the processor is further configured to:
detect the user action on one of the at least two inactive commands, wherein the user action includes one or more of: a tap action, a swipe action, a press and hold action, a keyboard entry combination, a mouse input and a pen input on; and
continuously display new additional commands in the base set of commands in response to the user action on one of the at least two inactive commands, wherein the new additional commands are continuously displayed in a carousel configuration.

14. The computing device of claim 12, wherein the processor is further configured to:
display at least three most frequently used set of commands for interacting with the selected portion of content in the base set of commands.

15. The computing device of claim 12, wherein the processor is further configured to:
display at least three most recently used set of commands for interacting with the selected portion of content in the base set of commands.

16. The computing device of claim 12, wherein the processor is further configured to:
detect a selection of a command from the base set of commands;
perform the action associated with the command on the selected portion of content; and
store the command selection in a user profile associated with a user.

17. The computing device of claim 16, wherein the processor is further configured to:
prioritize the stored selections in the user profile according to a most frequent command selection;
detect a selection of a similar portion of content by the user; and
display the most frequently use commands from the user profile in a context menu associated with the similar portion of content.

18. A computer-readable memory device with instructions stored thereon for providing a scrollable smart context menu, the instructions containing:
detecting selection of a portion of content displayed on a user interface of a client device;
displaying a context menu including a base set of commands for interacting with the selected portion of content wherein the base set of commands includes at least three commands most frequently used by a user interacting with a similar portion of content;
displaying at least two inactive commands, wherein one inactive command precedes the base set of commands and one inactive command follows the base set of commands to indicate that one or more additional commands are available for execution on the selected portion of content;
detecting a user action to navigate to the one or more additional commands;
upon detection of selection of an additional command, displaying a new base set of commands; and
rendering and activating the commands displayed in the new base set of commands.

19. The computer-readable memory device of claim 18, wherein instructions further comprise:
upon detection of the user action to navigate to the one or more additional commands, displaying an expanded region of the base set of claims, wherein the expanded region includes two or more additional commands.

20. The computer-readable memory device of claim 18, wherein instructions further comprise:
marking the at least two inactive commands according to one or more of: a shading scheme, a coloring scheme, a highlighting scheme and a magnifying scheme, to indicate that the commands are currently inactive.
